(19) United States
(12) Patent Application Publication
(10) Pub. No.: US 2002/0170990 A1
(43) Pub. Date: Nov. 21, 2002

(54) Connector assembly for a waste line in a food waste disposer

(76) Inventors: Scott W. Anderson, Racine, WI (US); Steve Landowski, Racine, WI (US); Terrence W. Montpas, Beach Park, IL (US); Joseph G. Farmerie, Muskego, WI (US); Larry Miletta, Pleasant Prairie, WI (US)

Correspondence Address: Terril G. Lewis, Howrey Simon Arnold and White LLP, 750 Bearing Dr., Houston, TX, 77057, US

(21) Appl. No.: 10/145,851

(22) Filed: May 14, 2002

Related U.S. Application Data
(60) Provisional application No. 60/291,388, filed on May 16, 2001.

(51) Int. Cl. B02C 18/42

(52) U.S. Cl. 241/46.014

(57) ABSTRACT

Connector assemblies for attaching a waste line to a waste disposer are disclosed. In one embodiment, the connector assembly includes a male member and a female member. The male member is coupled to the waste disposer and has one or more anchors. The female member is coupled to the waste line. The female member has one or more locking members adapted to lock the female member to the one or more anchors of the male member. In another embodiment, the connector assembly includes a mounting flange, a connector flange, and a locking member. The mounting flange is coupled to the disposer and has a locking portion and an anchor portion. The connector flange is coupled to the waste line and has a first portion. The anchor portion of the mounting flange holds the first portion of the connector flange adjacent the mounting flange. The locking member is attached to the locking portion and holds a second portion of the connector flange adjacent the mounting flange.

### CROSS-REFERENCE TO RELATED APPLICATIONS

This application claims the benefit of U.S. Provisional Application Serial No. 60/291,388 filed May 16, 2001.

### FIELD OF THE INVENTION

The present invention relates generally to food waste disposers and, more particularly, to a food waste disposer having a quick-lock connection assembly for the discharge outlet.

### BACKGROUND OF THE INVENTION

Referring to FIG. 1A, a typical food waste disposer is illustrated in cross-section. The disposer includes an upper food conveying section 12, a lower motor section 14, and a central grinding section 16 disposed between the food conveying section 12 and the motor section 14. The food conveying section 12 includes a housing 18 that forms an inlet 20 at its upper end for receiving food waste. The food conveying section 12 conveys the food waste to the central grinding section 16. The motor section 14 includes a motor 22 imparting rotational movement to a motor shaft 24. The motor 22 is enclosed within a motor housing 26. The grinding section 16 includes a grinding mechanism having lugs 36, a rotating plate 34, and a stationary shredder ring 38. The grinding mechanism is enclosed in a housing 40.

In the operation of the food waste disposer, the food waste delivered by the food conveying section 12 to the grinding section 16 is forced by lugs 36 against teeth 42 of the shredder ring 38. The edges of the teeth 42 grind the food waste into particulate matter sufficiently small to pass from above the grinding plate 34 to below the grinding plate 34 via gaps between the teeth 42 outside the periphery of the plate 34. Due to gravity, the particulate matter that passes through the gaps between the teeth 42 drops onto base frame 28. The particulate matter along with water injected into the disposer is then discharged through a discharge outlet 44 into a waste line 46. As best shown in FIG. 1B, the waste line 46 is connected to the discharge outlet 44 by a fitting consisting of a gasket 48, a flange 50, and a plurality of screws 52.

Referring to FIG. 2, a threaded discharge outlet 60 according to the prior art is illustrated in cross-section. The threaded discharge outlet 60 is disclosed in U.S. Pat. No. 6,007,006, which is owned by the assignee of the present application and incorporated herein by reference. The discharge outlet 60 includes a threaded housing 62 having an opening 64 communicating with the grinding section 16. A threaded flange or plumbing nut 68 is disposed on a waste line 66. The plumbing nut 68 engages a rim 67 on the end of the waste line 66.

To connect the waste line 66 to the discharge outlet 60, an installer positions the rim 67 adjacent the opening 64 and threads the plumbing nut 68 onto the threaded housing 62. A gasket (not shown) may be used between the waste line 66 and the housing 62. By designing the discharge outlet 60 to accept the standard plumbing nut 68, the food waste disposer is significantly easier to connect to a plumbing system in the field than existing disposers are. Unlike the prior art disposer in FIGS. 1A-B, there is no need for a fitting consisting of numerous components.

Although the threaded discharge outlet 60 of FIG. 2 is one way of providing an easier way to connect the discharge outlet to a waste line, manufacturers are continually striving to provide quicker and easier ways to connect a waste line of a plumbing system to a discharge outlet of a food waste disposer. This concern has become an issue more recently due to an increase in the “do-it-yourself” market.

Installers in the past and present have become accustomed to the prior discharge connections, which can be difficult to assemble. For example, the use of screws for the discharge connection in FIG. 1B requires the installer to use a tool. In the tight quarters of a normal food waste disposer installation, the use of a tool may not always be practical. In another example, the use of the threaded plumbing nut 68 and housing 62 in FIG. 2 requires the installer to perform a number of turns to make a tight connection between the waste line 66 and the housing 62. The manual dexterity required of the installer may not always be practical in the tight quarters typically found in the normal installation of food waste disposers.

Any type of connection between a waste line and a discharge outlet must be robust enough to withstand the environment and to resist the potential of leaking. Various materials may be entered into the disposer during normal operation. Moreover, various substances may contact the exterior of the food waste disposer during a normal installation. Unexpected leaking of the discharge connection may have undesirable affects to the surroundings.

The connection must also be able to accommodate the many types of household plumbing configurations. Plumbing installations may vary for a number of reasons, such as the age of the home, local codes, or individual preferences. Because there are millions of installations around the world, accommodating replacements and new installations is imperative. The present invention allows for not only the use of a waste line or tailpipe, but also a straight pipe or any other standard plumbing drain that may be used in this type of application.

The connection of the waste line must further accommodate the various skill levels of those persons who seek to install or repair a food waste disposer. This concern is growing as the number of the “do-it-yourselfer's” increases. Disposers are not only installed by trained professionals, but are installed by homeowners or others. Thus, the plumbing connection to the food waste disposer discharge needs to be easy and reliable.

The present invention is directed to overcoming, or at least reducing the effects of, one or more of the problems set forth above.

### SUMMARY OF THE INVENTION

Connector assemblies for attaching a waste line to a waste disposer are disclosed. In one embodiment, the connector assembly includes a male member and a female member. The male member is coupled to the waste disposer and has one or more anchors. The female member is coupled to the waste line and has one or more locking members adapted to lock the female member to the one or more anchors of the male member. In another embodiment, the connector assembly includes a mounting flange, a connector flange, and a locking member. The mounting flange is coupled to the disposer and has a locking portion and an anchor portion. The connector flange is coupled to the waste line and has a first portion. The anchor portion of the mounting flange holds the first portion of the connector flange adjacent the mounting flange. The locking member is attached to the locking portion of the mounting flange and holds a second portion of the connector flange adjacent the mounting flange.

### BRIEF DESCRIPTION OF THE DRAWINGS

The foregoing summary, a preferred embodiment, and other aspects of the present invention will be best understood with reference to a detailed description of specific embodiments of the invention, which follows, when read in conjunction with the accompanying drawings, in which:

FIGS. 1A illustrates a cross-section of a typical food waste disposer according to the prior art.

FIG. 1B illustrates an enlarged cross-section of a portion of the disposer in FIG. 1 showing a discharge outlet connected to a waste line.

FIG. 2 illustrates an enlarged cross-section of another discharge outlet connected to a waste line according to the prior art.

FIGS. 3A-B, 4 and 5 illustrate various views and components of a first embodiment of a quick-lock connector assembly in accordance with the present invention.

FIGS. 6 and 7A-D illustrate various views and components of a second embodiment of a quick-lock connector assembly in accordance with the present invention.

FIGS. 8A-B, 9, and 10A-B illustrate various views and components of a third embodiment of a quick-lock connector assembly in accordance with the present invention.

FIGS. 11, 12, and 13 illustrate various views and components of a fourth embodiment of a quick-lock connector assembly in accordance with the present invention.

FIGS. 14, 15, and 16 illustrate various views and components of a fifth embodiment of a quick-lock connector assembly in accordance with the present invention.

FIGS. 17 and 18 illustrate various views of a sixth embodiment of a quick-lock connector assembly in accordance with the present invention.

FIGS. 19 and 20 illustrate various views of a seventh embodiment of a quick-lock connector assembly in accordance with the present invention.

FIGS. 21 and 22 illustrate various views of an eighth embodiment of a quick-lock connector assembly in accordance with the present invention.

While the invention is susceptible to various modifications and alternative forms, specific embodiments thereof have been shown by way of example in the drawings and will herein be described in detail. It should be understood, however, that it is not intended to limit the invention to the particular forms disclosed but, on the contrary, to cover all modifications, equivalents, and alternatives failing within the spirit and scope of the invention as defined by the appended claims.

### DETAILED DESCRIPTION OF THE INVENTION

In the interest of clarity, it is understood that not all features of actual implementations are described in the disclosure that follows. In an effort to develop an actual implementation, as in any project, numerous engineering and design decisions must be made to achieve the specific goals of the developer (e.g., compliance with mechanical-related and business-related constraints). The specific goals and constraints may vary from one implementation to another. Moreover, in the effort to develop the actual implementation, attention must necessarily paid to proper engineering and design practices for the environment in question. Such development efforts would be a routine undertaking for those of skill in the art having the benefit of the present disclosure.

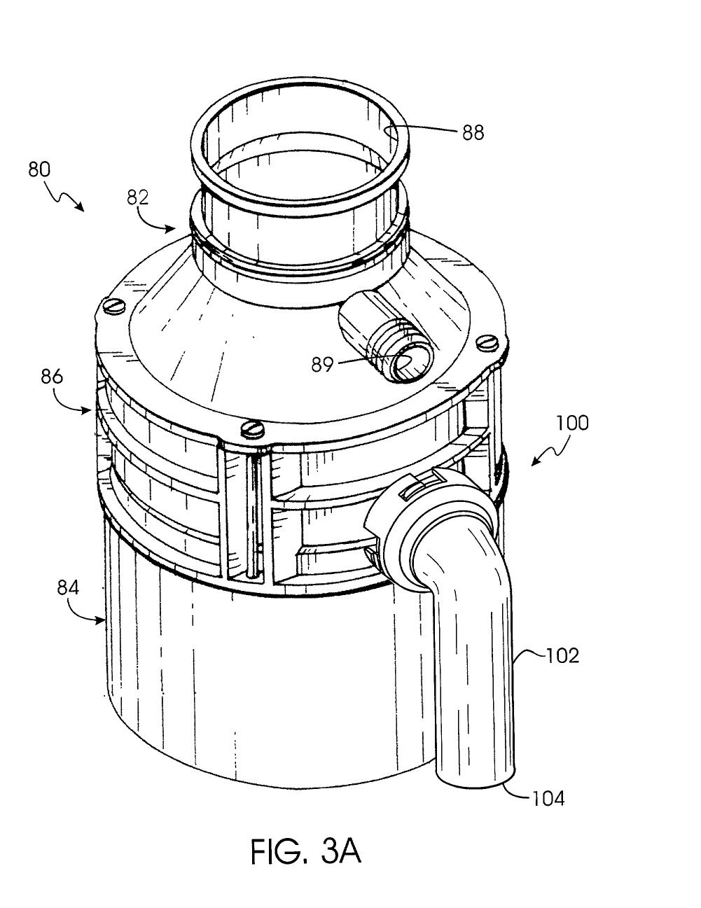

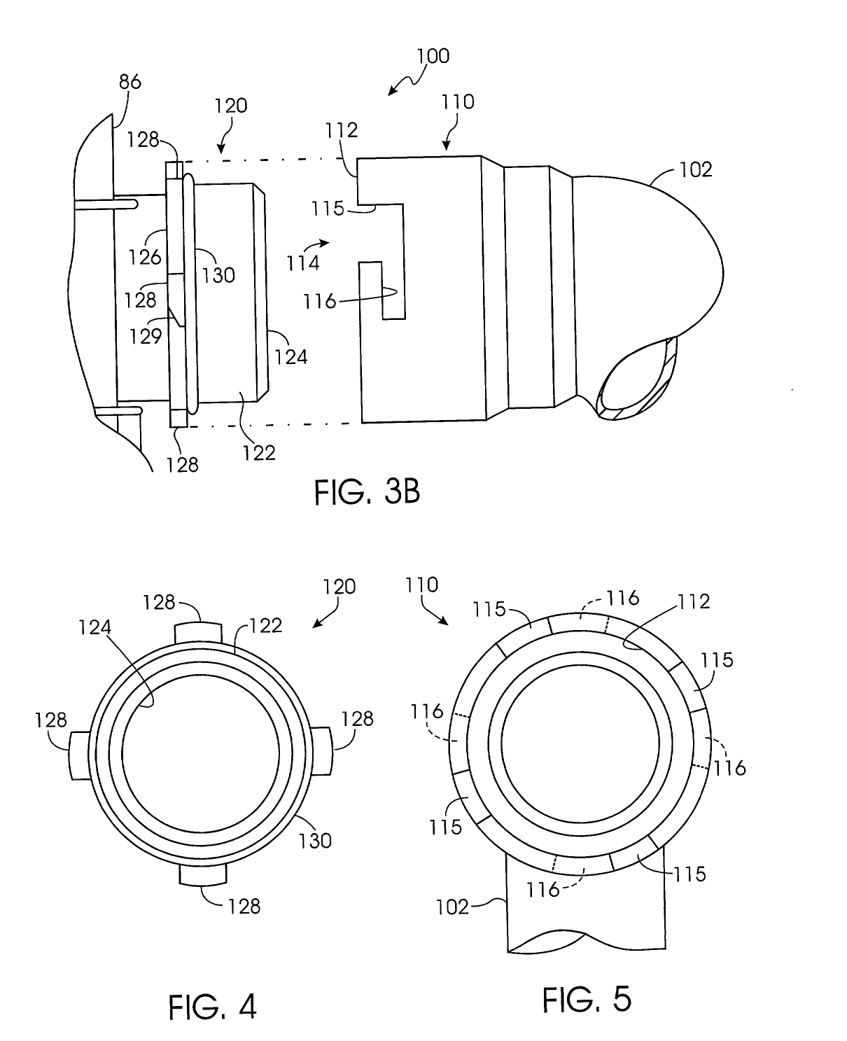

Referring to FIG. 3A, a food waste disposer 80 in accordance with the present invention is illustrated in a perspective view. The disposer 80 may be mounted in a well-known manner in the drain opening of a sink (not shown) using conventional mounting members (not shown) of the type disclosed in U.S. Pat. No. 3,025,007, which is owned by the assignee of the present application and incorporated herein by reference in its entirety. The disposer 80 includes an upper food conveying section 82, a lower motor section 84, and a central grinding section 86 disposed between the food conveying section 82 and the motor section 84. As in the prior art, the food conveying section 82 includes a housing, which forms an inlet 88 at its upper end for receiving food waste and water. The housing may also form an inlet 89 for passing water discharged from a dishwasher (not shown). The food conveying section 82 conveys the food waste to the central grinding section 86. The motor section 84 includes a motor imparting rotational movement to a motor shaft that assists in grinding operations. The grinding section 86 includes a grinding mechanism. For example, U.S. Pat. No. 6,007,006 discloses a grinding mechanism including swivel lugs fastened to a rotating plate attached to the motor shaft. A housing of the grinding section 86 encompasses the grinding mechanism.

A connector assembly 100 is used to attach the waste line 102 to the housing of the grinding section 86 of the disposer 80. Referring to FIG. 3B, an exploded side view of the quick-lock connector assembly 100 is illustrated. The connector assembly 100 includes a first connector or female member 110 and a second connector or male member 120. In FIG. 4, a front view of the male member 120 of FIG. 3B is illustrated. In FIG. 5, a front view of the female member 110 of FIG. 3B is illustrated.

In this first embodiment of a connector assembly for a waste line, the male member 120 is integrally formed or molded onto the housing of the grinding section 86, although it may also comprise a separate piece coupleable to the discharge outlet by any well-known method. The housing and male member 120 may be composed of injection-molded plastic, which exhibits impact resistance, heat resistance, and corrosion resistance. Some suitable plastic materials for the housing and male member 120 include acrylonitrile butadiene styrene (ABS), polyvinyl chloride (PVC), polyester (PE), and polyphenylene sulfide (PPS). The present invention is not, however, limited to connector assemblies made of plastic. The housing and male member 120 may also be made of metallic material, such as powdered metal or steel. In addition, the housing and male member 120 may be made by casting methods, such as die-casting or investment casting.

The male member 120 is shaped to receive the female member 110. In the present embodiment, the male member 120 includes a tubular body 122 having an opening 124 communicating with the grinding section 86. A locking ring 126 is disposed about the periphery of the tubular body 122. Adjacent the locking ring 126, the male member 120 also includes an annular slot (not shown), which receives an O-ring seal 130. The O-ring seal 130 helps prevent waste or water from leaking from the connection between the male and female members 110 and 120 of the assembly 100 once connected together. The locking ring 126 includes a plurality of anchors or tabs 128. The tabs 128 allow the female member 110 on the waste line 102 to connect to the male member 110 as described below.

The female member 110 is coupled to the waste line 102. In a preferred embodiment, the female member 110 is integrally formed or molded onto the waste line 102 so that the waste line 102 with integral female member 110 replaces any existing waste line under the sink. Additionally, the female member 110 could be readily designed to couple to an otherwise standard waste line already present ender the sink. The female member 110 has an open end 112 to receive the male member 120 and to communicate waste to the waste line 102. The female member 110 includes a plurality of locking members or slots 114 designed to receive the tabs 128 on the male member 110. The slots 114 include a first or guide portion 115 receiving one of the tabs 128 when the female member 110 is inserted on the male member 120. The slots 114 also include a second or retaining portion 116 receiving the tab 128 when the female member 110 is turned on the male member 120 as described below. Some suitable plastic materials for the female member 110 include acrylonitrile butadiene styrene (ABS), polyvinyl chloride (PVC), polyester (PE), and polyphenylene sulfide (PPS).

An installer assembles the connector assembly 100 by first positioning or anchoring the female member 110 onto the tubular body 122 of the male member 120. As noted above, the male member 120 is preferably already attached to or formed on the housing of the grinding section 86 by methods known in the art. The installer then aligns the guide portions 115 of the slots 114 with the tabs 128. The female member 110 is then pushed further onto the tubular body 122 over the O-ring seal 130. The tabs 128 enter the guide portions 115 of the slots 114. The operator then gives the female member 110 a short turn to install the tabs 128 into the retaining portions 116 of the slots. To facilitate the insertion of the tabs 128 into the retaining portions 116, the tabs 128 include slanted leading edges 129. When turning the female member 110, the leading edges 129 assist in further pressing the female member 110 onto the male member 120. With the female member 110 integrally connected to the waste line 102, the operator needs only to hold the waste line 102 when mating the members 110 and 120 and turning the female member 110 on the male member 120. The slight turning of the female member 110 using the waste line 102 is not significant enough to interfere with other components, pipes, or constructions under a sink.

Although the male member 120 includes four anchors or tabs 128 and the female member 110 includes four locking members or slots 114 in the present embodiment, it is understood that more or fewer tabs 128 and slots 114 can be sufficient for connecting the male and female members 110 and 120 together. In addition, it will be appreciated that one tab and one slot can be sufficient, depending on a number of factors. Some of the factors include, for example, the depth that the male member 120 extends within the female member 110 once connected and the circumference that the one tab and slot encompass on the members 110 and 120.

The female member 110 is kept from turning on the male member 120 by friction with the gasket 130. In addition, the tabs 128 can include detents (not shown) locking in indentations (not shown) on the slots 114 to prevent turning of the female member 110 on the male member 120. Once the connector assembly 100 connects the waste line 102 to the disposer 80 as shown in FIG. 3A, an installer can then attach a free end 104 of the waste line 102 to the drain line (not shown) under the sink. For example, the free end 104 of the waste line 102 can be connected to a drain trap (not shown) with a p-trap nut and a beveled washer as is known in the art. During installation of the disposer 80 under the sink, the dimensions of the connector assembly 100 and waste line 102 preferably do not require significant alterations to the existing plumbing configuration; however, it is understood that extensions or modifications may be necessary depending on the size of the disposer 80, existing plumbing configuration, etc. Once connected to the disposer 80, the waste line 102 may generally extend approximately 1 ¼-inches to 2 ¾-inches from the housing of the grinding section 86 and may generally extend approximately 4-inches downward from the discharge outlet of the grinding section 86. In addition, the discharge outlet of the grinding section 86 may be approximately 6 inches to nearly 10 inches from the bottom of the sink. It is understood that these dimensions are intended only to provide example dimensions and are not intended to limit the present invention.

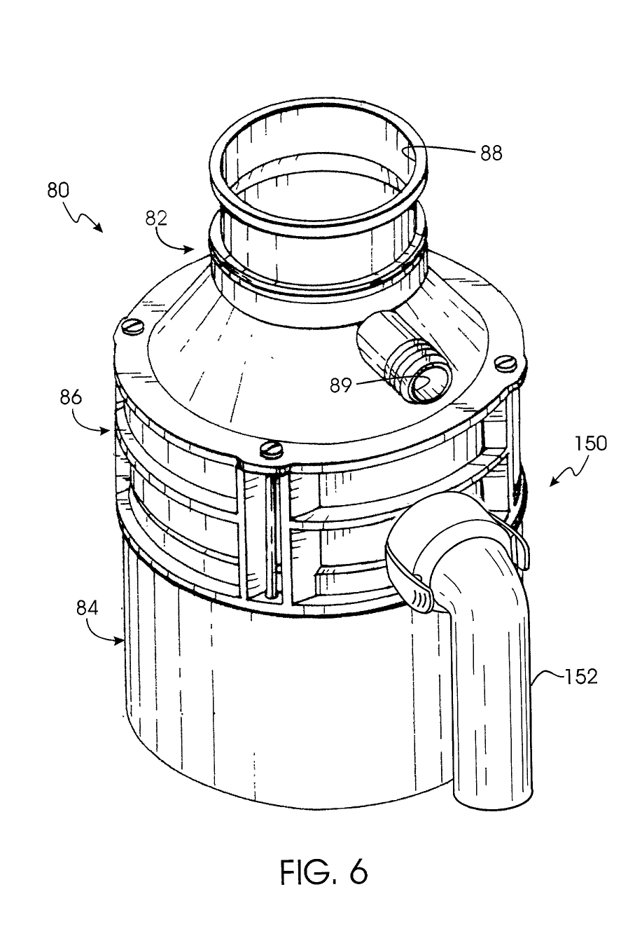

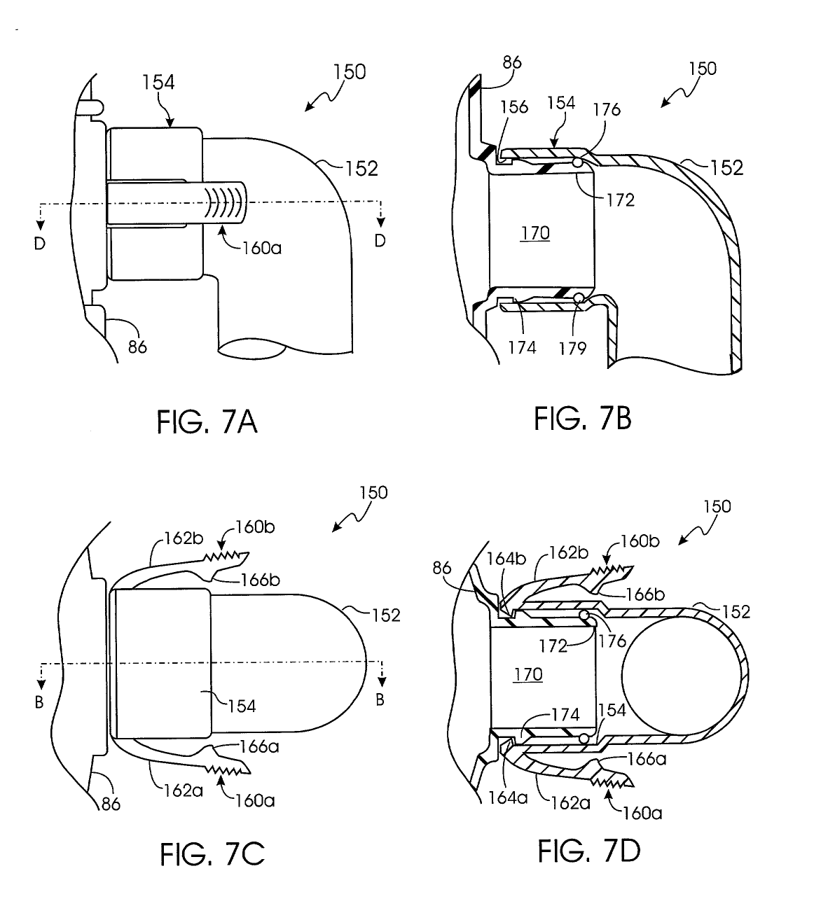

Referring to FIGS. 6 and 7A-7D, a second embodiment of a connector assembly 150 for connecting a waste line or tail pipe 152 to a disposer 80 is illustrated in accordance with the present invention. In FIGS. 7A-D, the connector assembly 150 is illustrated respectively in a side view, a side cross-sectional view, a top view, and a top cross-sectional view. The connector assembly 150 includes a first connector or female member 154 and a second connector or male member 170. In one embodiment, the male member 170 is integrally formed or molded on the housing of the grinding section 86, although this is not strictly necessary as noted earlier. The housing and male member 170 may be composed of injection-molded plastic, such as acrylonitrile butadiene styrene (ABS), polyvinyl chloride (PVC), polyester (PE), and polyphenylene sulfide (PPS). The housing and male member 170, however, may also be made of metallic material, such as powdered metal or steel, and may be made by casting methods, such as die-casting or investment casting.

As best shown in the cross-sectional views of FIGS. 7B and 7D, the male member 170 defines an opening 172 for the passage of water and waste from the grinding section 86 to the waste line 152. The male member 170 includes an anchor or locking ridge 174. Adjacent the opening 172, the male member 170 also includes an annular slot 179, which receives an O-ring seal 176. The O-ring seal 176 helps prevent waste or water from leaking from the connector assembly 150 when assembled. The locking ridge 174 allows the female member 154 on the waste line 152 to lock to the male member 170 as described below.

In the present embodiment, the female member 154 is integrally formed or molded onto the waste line 152. Alternatively, in this and other embodiments, the female member 154 could be a separate component from the waste line 152. The female member 154 includes a first locking member or lever 160a and a second locking member lever 160b. The levers 160a and 160b are disposed on opposite sides of the member 154 and are designed to lock the female member 154 to the male member 170. Some suitable plastic materials for the female member 154 include acrylonitrile butadiene styrene (ABS), polyvinyl chloride (PVC), polyester (PE), and polyphenylene sulfide (PPS).

Each lever 160a and 160b is flexibly attached to the female member 154. As best shown in FIGS. 7C and 7D, the levers 160a and 160b are each formed as one unitary plastic piece with the female member 154. Alternatively, the levers 160a and 160b may be separate components and attached to the female member 154 via a pin and spring mechanism (not shown). Each lever 160a and 160b includes a flexible portion 162a and 162b. One end of each lever 160a and 160b includes a catch or tooth 164a and 164b. The other end of each lever 160a and 160b extends adjacent the female member 154 and may include a grip surface and a squeeze stop 166a and 166b.

The female member 154 has an open end 156 to receive the male member 170 and to communicate waste to the waste line 152. An installer assembles the connector assembly 150 by first positioning or anchoring the female member 154 onto the male member 170. The members 154 and 170 need not be aligned in any particular fashion. To install the female member 154, the female member 154 is pushed onto the male member 170 and the O-ring seal 176 until the teeth 164a and 164b of the levers 160a and 160b surpass the locking ridge 174. To remove the female member 154 from the male member 170, the installer can squeeze the levers 160a and 160b to disengage the teeth 164a and 164b from the locking ridge 174. Simultaneously, the installer can pull the female member 154 off the male member 170 and the O-ring seal 176 until the teeth 164a and 164b are clear of the male member 170.

Although the male member 170 includes the single anchor or locking ridge 174 and the female member 154 includes two locking members or levers 160a and 160b in the present embodiment, it is understood that more or fewer ridges 174 and levers 160 can be sufficient for connecting the male and female members 154 and 170 together. In addition, it will be appreciated that one locking ridge and one lever can be sufficient, depending on a number of factors. Some of the factors include, for example, the depth that the male member 170 extends within the female member 154 once connected and the circumference that the tooth of the one lever encompasses on the locking ridge.

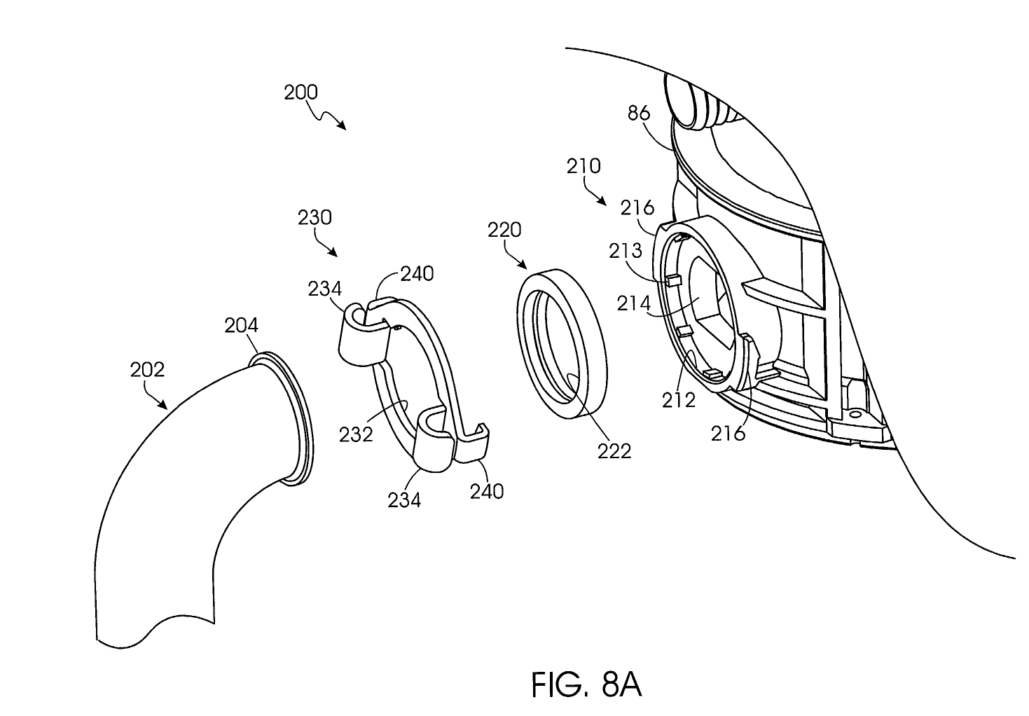

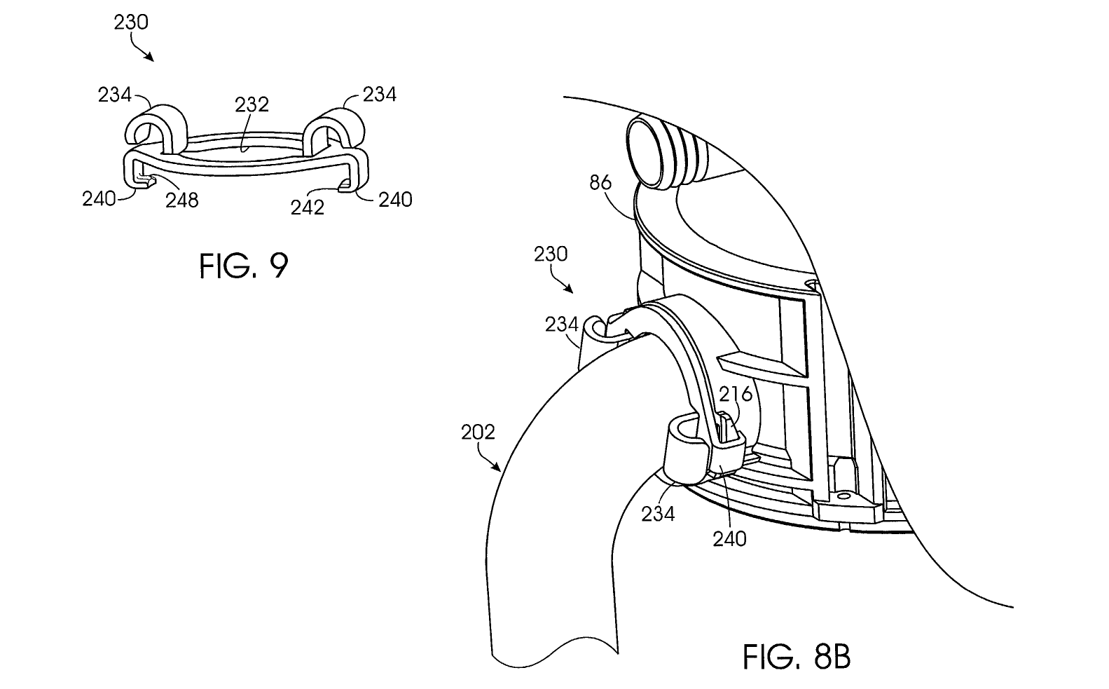

Referring to FIGS. 8A-B, 9, and 10A-B, a third embodiment of a connector assembly 200 for a disposer is illustrated in accordance with the present invention. In FIG. 8A, the connector assembly 200 is illustrated in an exploded view. In FIG. 8B, the connector assembly 200 is shown assembled and connecting a waste line 202 to a grinding section 86 of the disposer.

The connector assembly 200 includes a first connector or mounting flange 210, a gasket 220, a second connector or connector flange 230, and locking members 240. The connector flange 230 is preferably composed of a metallic material, but can be composed of a plastic material. The connector flange 230, which is illustrated in a perspective view in FIG. 9, includes an opening 232 for the waste line 202 and includes wings 234 for an operator to turn the flange 230. The connector flange 230 also includes the plurality of locking members 240. The locking members 240 are anchoring and locking hooks disposed about the periphery of the connector flange 230 and extending from one side. The hooks 240 include end portions 242, which extend inward toward the opening 232 of the connector flange 230. The end portions 242 preferably include raised portions 248, which act as detents when the connector flange 230 is connected to the mounting flange 210 as described below.

The mounting flange 210 is illustrated in a side view and a front view in FIGS. 10A-B. Preferably, the mounting flange 210 is integrally formed or molded onto the housing of the grinding section 86, although this is not strictly necessary as noted earlier. The mounting flange 210 includes anchors or tabs 216 disposed about the periphery of the flange 210. As best shown in FIG. 10A, each of the anchor tabs 216 preferably includes a slanted leading end 217 and preferably includes an indented portion 218 adjacent a stop 219.

An installer assembles the connector assembly 200 by first disposing the connector flange 230 on the waste line 202. The installer positions the gasket 220 in the well 212. The well 212 preferably includes crush ribs 213 to temporarily hold the gasket 220. The installer then positions the connector flange 230 adjacent the mounting flange 210. Extending from the side of the connector flange 230, the hooks 240 dispose about or anchor on the cylindrical body of the mounting flange 210. The installer turns the connector flange 230 clockwise using the wings 234. For example, the installer may turn the connector flange 230 by hand, adjustable wrench, or ¼″ hex wrench. The hooks 240 lock on the tabs 216 of the mounting flange 210. In particular, the end portions 242 of the hooks 240 surpass the slanted ends 217, and the raised portions 248 of the hooks 240 dispose in the indented portions 218. The stop 219 prevents over turning of the connector flange 230. This system may provide tool free installation for the installer.

Although the first connector 210 includes two anchors or tabs 216 and the second connector 230 includes two locking members or hooks 240 in the present embodiment, it is understood that more or fewer tabs 216 and hooks 240 can be sufficient for connecting the connectors 210 and 230 together. In addition, it will be appreciated that one tab and one hook can be sufficient, depending on a number of factors. One factor includes, for example, the circumference that the tab and hook encompasses on the connectors 210 and 230.

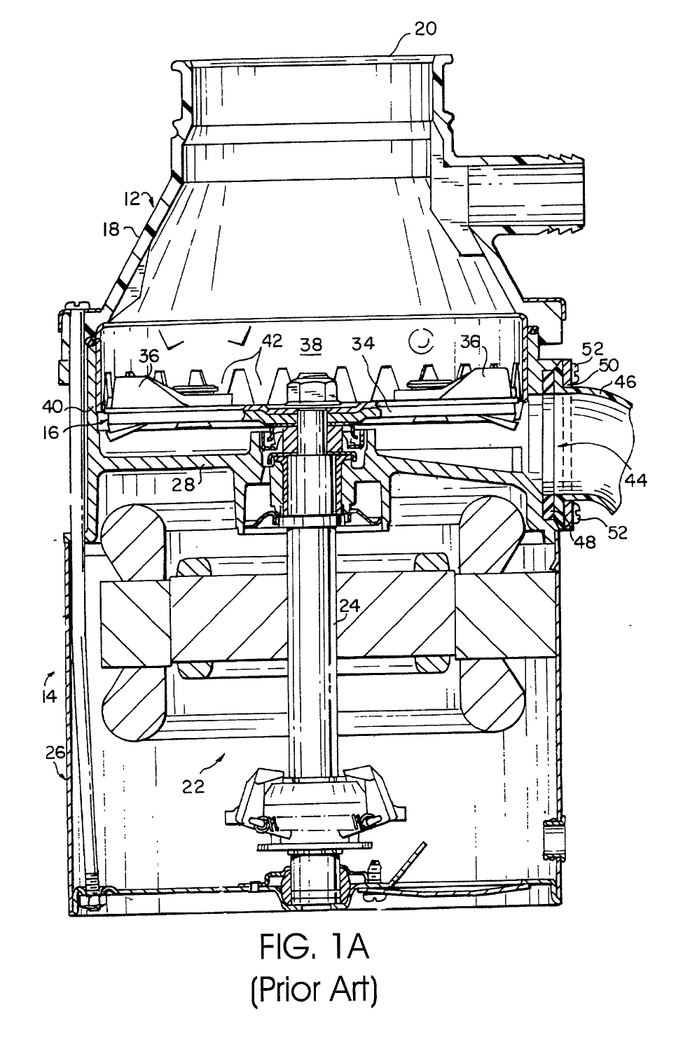

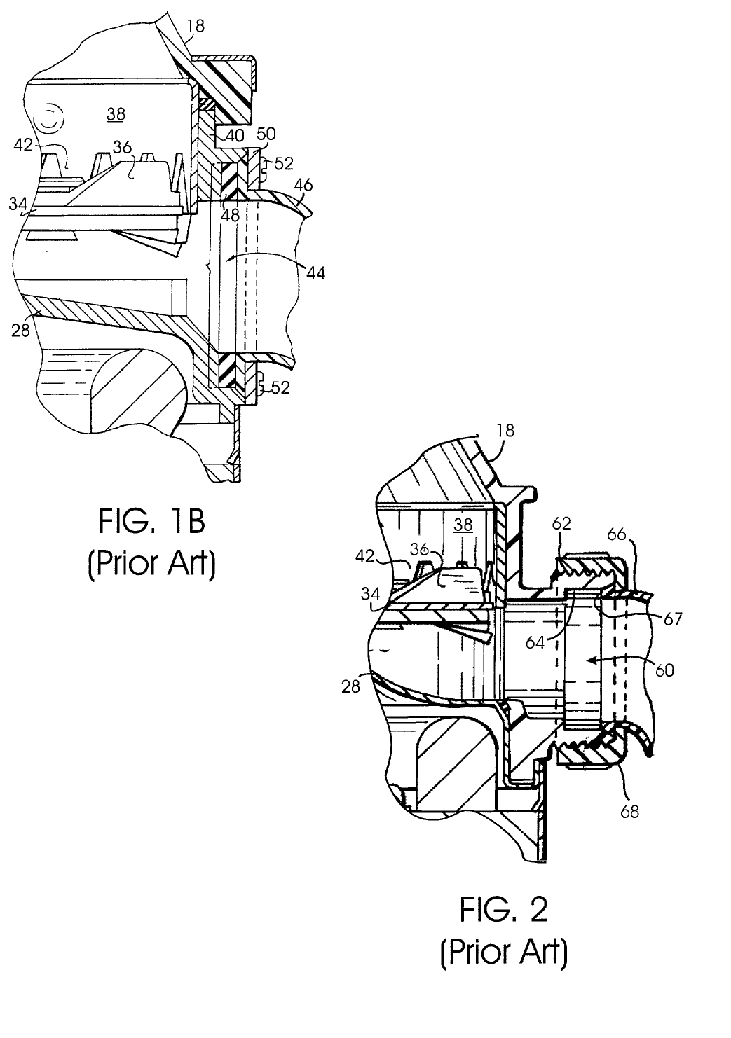

The quick-lock connector assemblies 100, 150, and 200 of FIGS. 3-10 are significantly easier to connect to a plumbing system in the field than is found with existing connections to disposers. Unlike the prior art disposer in FIGS. 1A-B, there is no need for a fitting consisting of numerous components to connect the drain line to the discharge outlet of the disposer. Unlike the prior art disposer in FIG. 2, there is no need for the installer to perform numerous, tedious turns of a threaded plumbing nut to make the connection. Furthermore, the quick-lock connector assemblies 100, 150, and 200 of FIGS. 3-10 also provide visual and tactile feedback to the installer that the assembly or installation has been done correctly. Prior art methods, such as threading a plumbing nut, do not typically provide such positive and distinct feedback that the assembly or installation has been done correctly or completely.

As described above, the embodiments of the quick-lock connector assemblies 100, 150, and 200 of FIGS. 3-10 include first connectors or male members coupled to a disposer and having one or more anchors. The connector assemblies 100, 150, and 200 also include second connectors or female members coupled to the waste line and having one or more locking members. To connect the waste line to the disposer, the locking members are adapted to lock the second connector to the one or more anchors of the first connector.

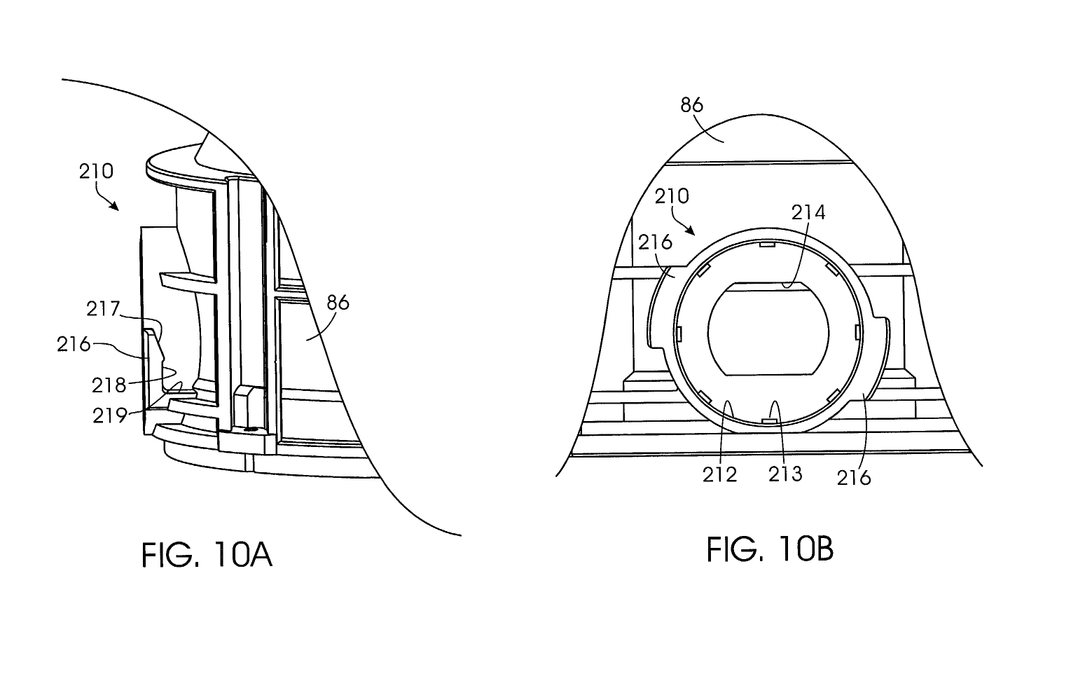

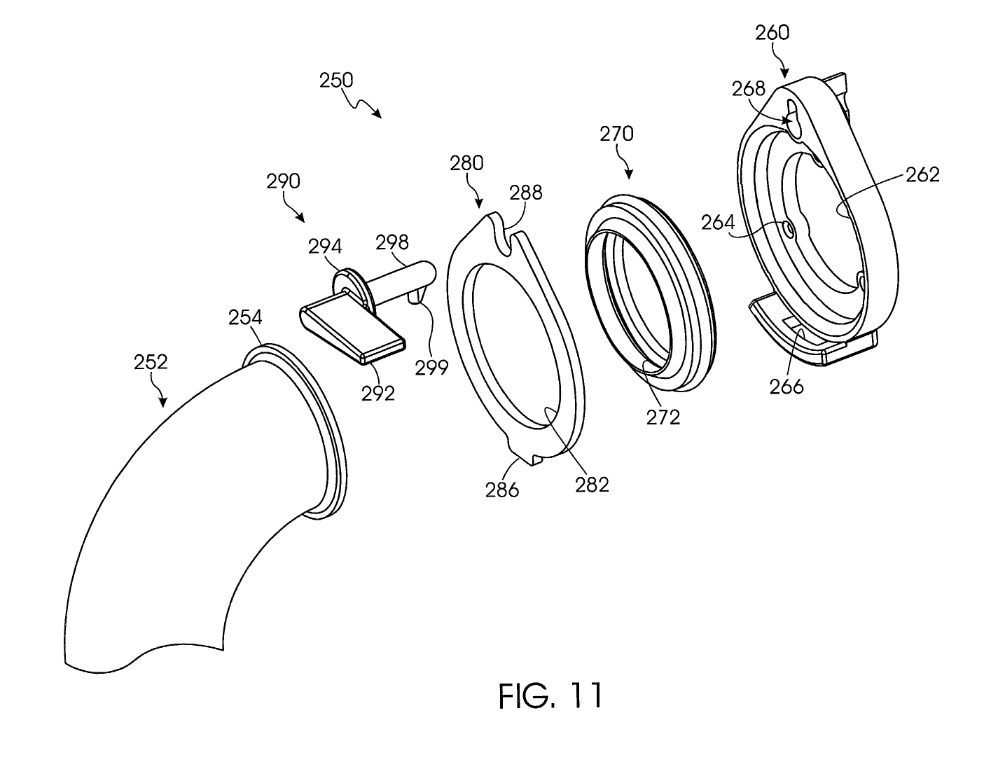

Additional embodiments of quick-lock connector assemblies will now be discussed with reference to FIGS. 11-22. The connector assemblies in the following embodiments include first connectors or mounting flanges coupled to a disposer and having a locking portion and an anchor portion. The following connector assemblies also include second connectors or connector flanges coupled to the waste line and having a first portion. To connect the waste line to the disposer, the anchor portion of the mounting flange holds the first portion of the connector flange adjacent the mounting flange. A locking member attaches to the locking portion of the mounting flange and holds a second portion of the connector flange adjacent the mounting flange.

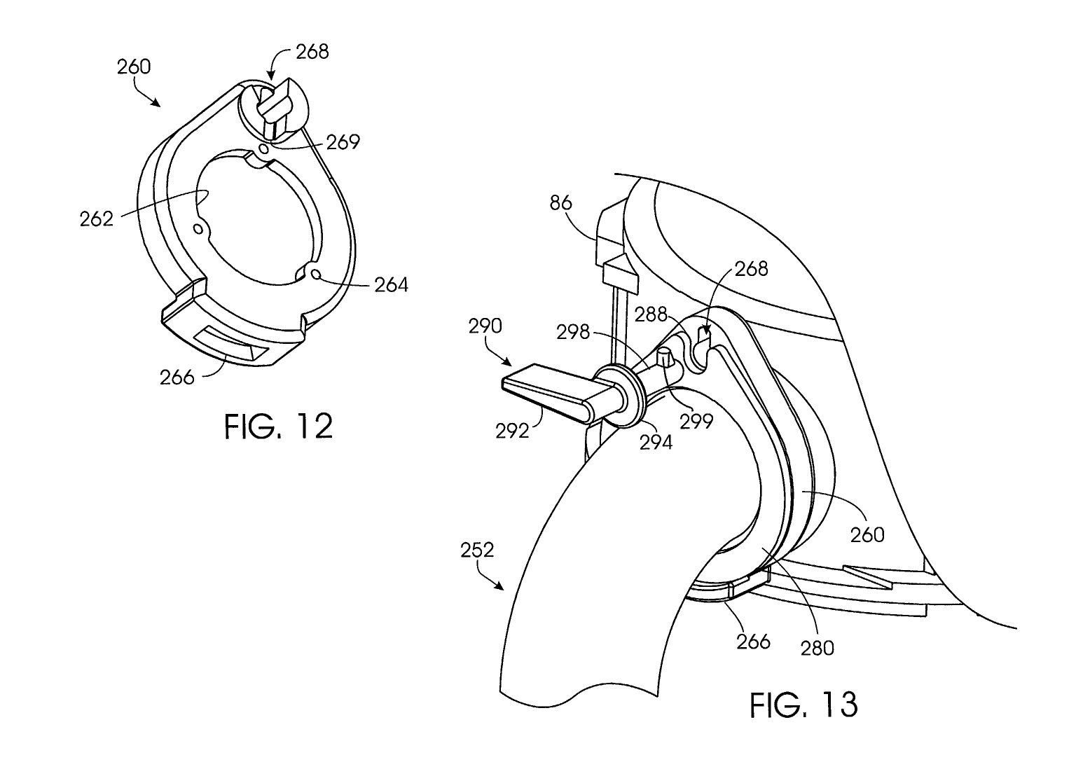

Referring to FIGS. 11-13, a fourth embodiment of a connector assembly 250 for a disposer is illustrated in accordance with the present invention. In FIG. 11, the connector assembly 250 is illustrated in an exploded view. The connector assembly 250 includes a first connector or mounting flange 260, a gasket 270, a second connector or connector flange 280, and a locking member 290. In FIG. 12, the mounting flange 260 is illustrated in a perspective view. In FIG. 13, the connector assembly 250 is shown assembled and connecting a waste line 252 to a grinding section 86 of a disposer.

The connector assembly 250 in the present embodiment accommodates many types of disposers in use and on the market today. The mounting flange 260 is preferably composed of a metallic material, but can be composed of a plastic material. The mounting flange 260 is configured to accept the locking member or key 290 instead of a threaded bolt or plumbing nut as seen in the prior art. As best shown in FIG. 11, the mounting flange 260 defines a well 262 having an opening for the passage of waste from the grinding section of the disposer to the waste line 252.

In the present embodiment, the mounting flange 260 includes mounting holes 264 for fasteners (not shown) that attach the flange 260 to the housing of the grinding section. Alternatively, the mounting flange 260 can be integrally formed or molded on the housing of the grinding section, or the flange 260 can be attached by other well-known methods. However, the mounting flange 260 is preferably pre-attached to the grinding section and does not require an installer to assemble, screw, bolt, or press-fit the flange 260 to the grinding section. The mounting flange 260 includes an anchor portion 266, which is a slot defined in a ledge extending from the bottom of the flange 260. The mounting flange 260 also includes a locking portion 268, which is a keyhole for the locking member 290.

The gasket 270 includes an annular slot 272 about its inner diameter. The gasket 270 fits on the rim 254 of the waste line 252 and disposes in the well 262 of the mounting flange 260 to seal the passage of waste from the grinding section of the disposer to the waste line 252. The gasket 270, which is preferably composed of an elastomeric material, relies primarily upon a diametrical seal and relies secondarily on a compression seal.

The connector flange 280 is preferably composed of a metallic material, but can be composed of a plastic material. The connector flange 280 includes an opening 282, which accommodates the waste line 252. The connector flange 280 also includes a first portion or anchor tab 286 and a second portion or locking slot 288. The anchor tab 286 mates with the anchor slot 266 on the mounting flange 260, and the locking slot 288 accommodates the locking member 290 as described below.

The locking member 290 is preferably cast and can be composed of a plastic or metallic material. The locking member 290 includes a handle 292, a flange 294, and a key portion 298. The key portion 298 extends from the flange 292 and includes a catch or tooth 299 disposed on its distal end. As best shown in FIG. 12, the keyhole 268 of the mounting flange 260 has a detent 269 on the backside. The detent 269 is used to retain the tooth 299 as described below.

The installer assembles the connector assembly 250 by fitting the gasket 270 on the rim 254 of the waste line 252. The rim 254 fits into the inner, annular slot 272 defined about the inside of the gasket 270. The installer then disposes the waste line 252 through the opening 282 of the connector flange 280. The waste line 252 can be composed of a plastic or metallic material. The gasket 270 and rim 254 on the waste line 252 engage the connector flange 280. (Alternatively, in this and other disclosed embodiments, the connector flange 280 and waste line 252 could be integrally formed, in which case some modification of the gasket may be necessary.) The installer positions the anchor tab 286 of the connector flange 280 in the anchor slot 266 of the mounting flange 260.

The connector flange 280 with waste line 252 is then tilted adjacent the mounting flange 260 as shown in FIG. 13. The gasket 270 on the rim 254 is engaged in the well 262 of the mounting flange 260. The locking slot 288 on the connector flange 280 is positioned adjacent the keyhole 268 located on the mounting flange 260. The installer then positions the key 298 of the locking member 290 into the keyhole 268. The key 298 is inserted until the flange 294 engages the connector flange 280. The installer then turns the locking member 290. After turning about 180-degrees clockwise, the catch 299 on the key 298 rests in the detent 269 shown in FIG. 12 to resist accidental loosening.

One end of the connector flange 280 is anchored or held in place to the mounting flange 260 by the anchor tab 286 disposed in the anchor slot 266. The other end of the connector flange 280 is held adjacent the mounting flange 260 by the locking flange 292 engaging the second portion 288 of the flange 280. The rim 254 of the waste line 252 is captured within the gasket 270 between the connector flange 280 and the mounting flange 260. The gasket 270 is sandwiched in the well 262 of the mounting flange 260 so that a substantially leak-proof seal is formed between the waste line 252 and mounting flange 260 of the grinding section 86.

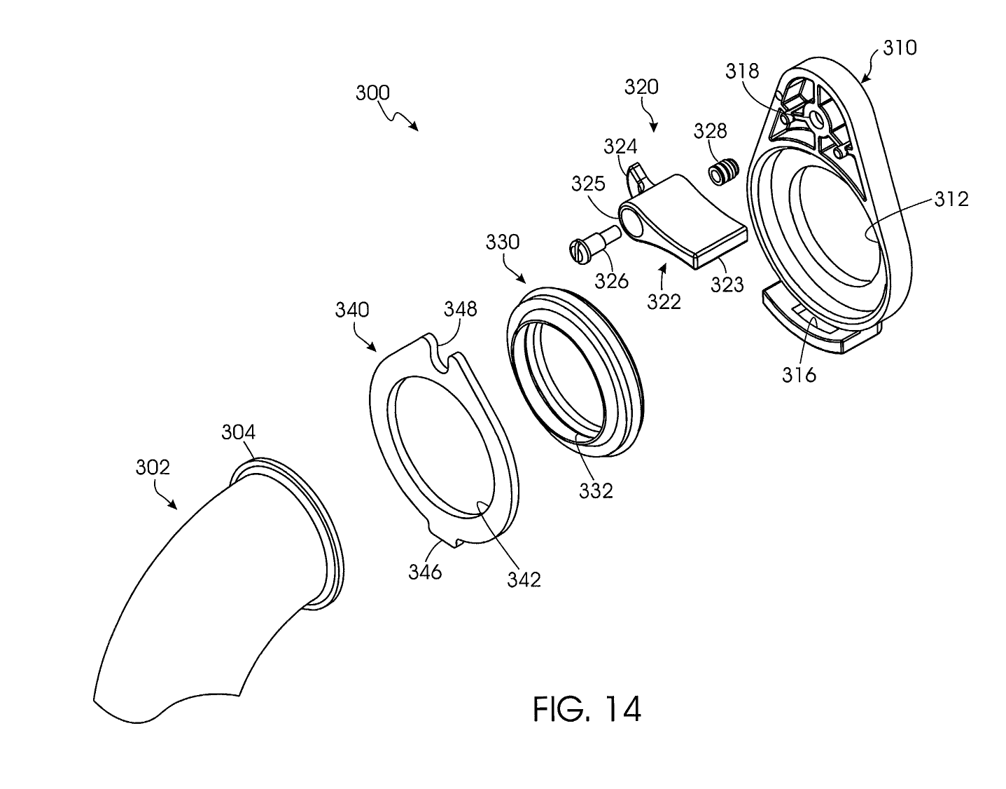

Referring to FIGS. 14, 15 and 16, a fifth embodiment of a connector assembly 300 for a disposer is illustrated in accordance with the present invention. In FIG. 14, the connector assembly 300 is illustrated in an exploded view. In FIG. 16, the connector assembly 300 is shown assembled for connecting a waste line 302 to a grinding section (not shown) of a disposer. The connector assembly 300 includes a first connector or mounting flange 310, a locking member 320, a gasket 330, and a second connector or connector flange 340.

The mounting flange 310 includes a locking portion 318, which is a hole in the present embodiment. The connector flange 340 includes an anchor tab 346 at one end and a locking slot 348 at another end. The locking member 320 includes a rotatable member 322 having a handle portion 323 and a cam 324. The rotatable member 322 can be composed of a plastic or metallic material. The locking member 320 also utilizes a shoulder bolt 326 and an insert 328.

The insert 328 is disposed in the hole 318 and is permanently affixed to the mounting flange 310. The shoulder bolt 326 disposes through an aperture 325 defined in the rotatable member 322. The shoulder bolt 326 secures the rotatable member 322 to the mounting flange 310 by threading into the insert 328 that is affixed in the hole 318. Alternatively, the threaded insert 328 may be replaced by a threaded hole in the mounting flange 310 in which the shoulder bolt 326 threads. Alternatively, the shoulder bolt 326 may be replaced by a screw and bushing assembly. Moreover, it is understood that the rotatable member 322 may be retained to the mounting flange 310 by a number of methods known in the art.

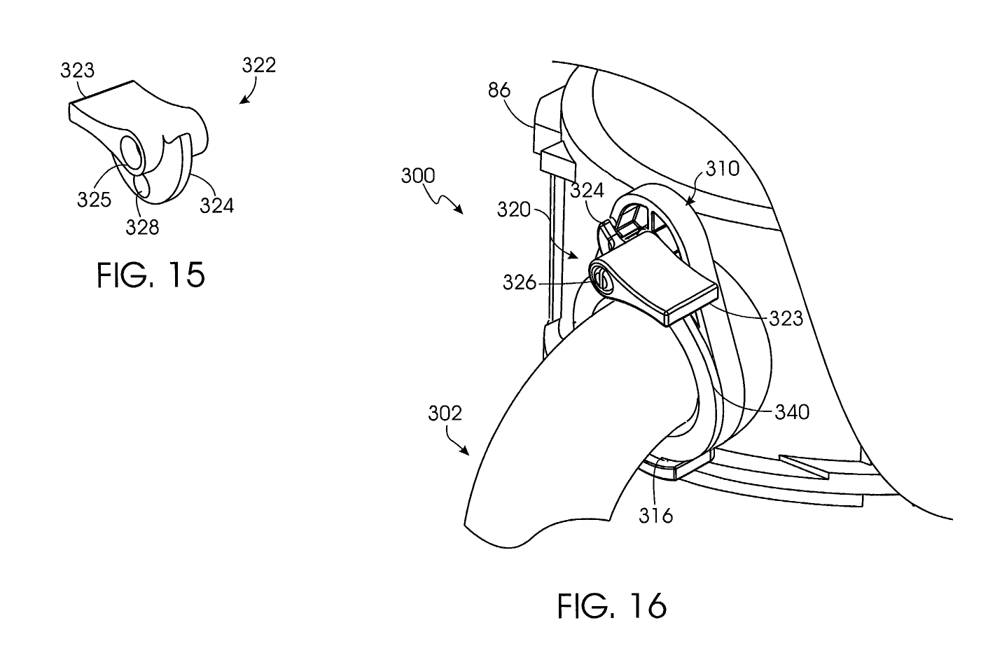

After fitting the gasket 330 on the rim 304 of the waste line 302, disposing the connector flange 340 on the waste line 302, and anchoring the connector flange 340 as described previously, the installer tilts the second portion 348 of the connector flange 340 adjacent the mounting flange 310. In a preferred embodiment, the rotatable member 322 is already attached to the mounting flange 310 so that the installer is not required to pre-assemble or attach the components of the locking mechanism 320. The rotatable member 322 is positioned so that the cam 324 allows the end of the connector flange 340 with locking aperture 348 to position adjacent the mounting flange 310. As best shown in a back view of the rotatable member 322 in FIG. 15, the cam 324 is formed on only the bottom portion of the handle 323 and has a detent 328 on its back surface.

With the cam 324 turned to allow the end of the connector flange to position adjacent the mounting flange 310, the installer then rotates the rotatable member 322 clockwise 180-degrees. The cam 324 engages the connector flange 340 as shown in FIG. 16 by positioning against the outside face of the flange 340. The cam 324 can include an angled surface, which increasingly presses against the end of the connector flange 340. The detent 328 shown in FIG. 15 on the back surface of the cam 324 rests in the locking aperture 348 of the connector flange 340 to resist accidental turning of the rotatable member 322.

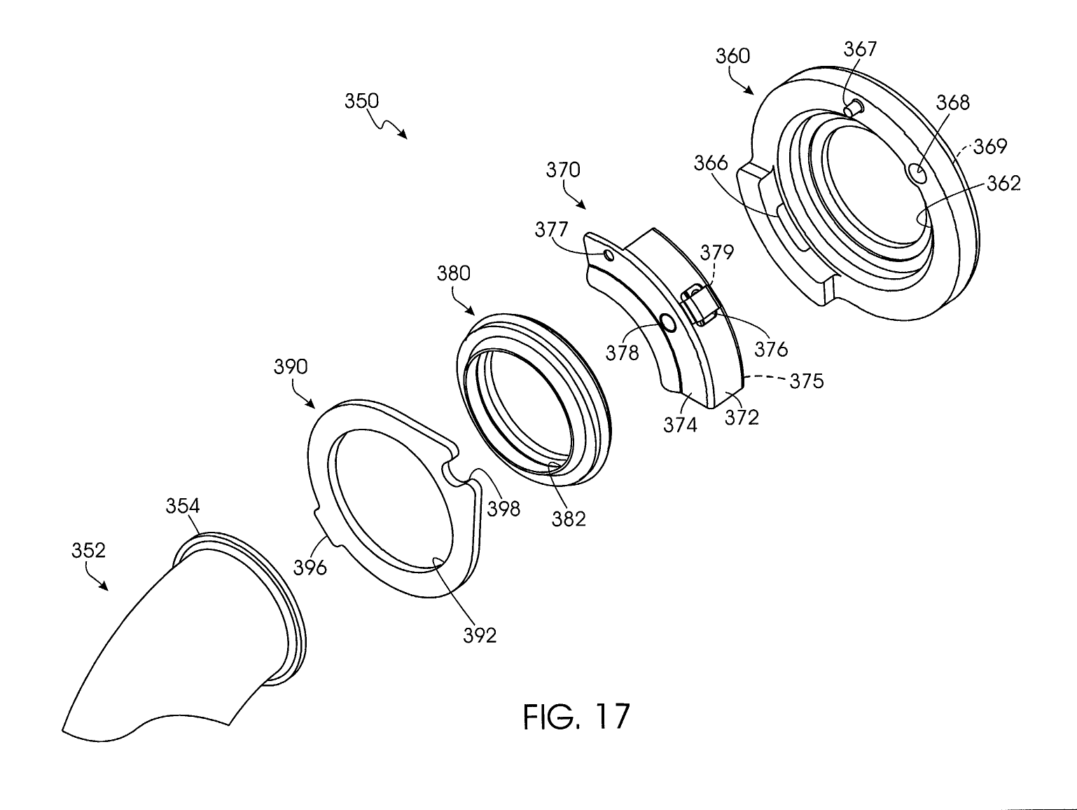

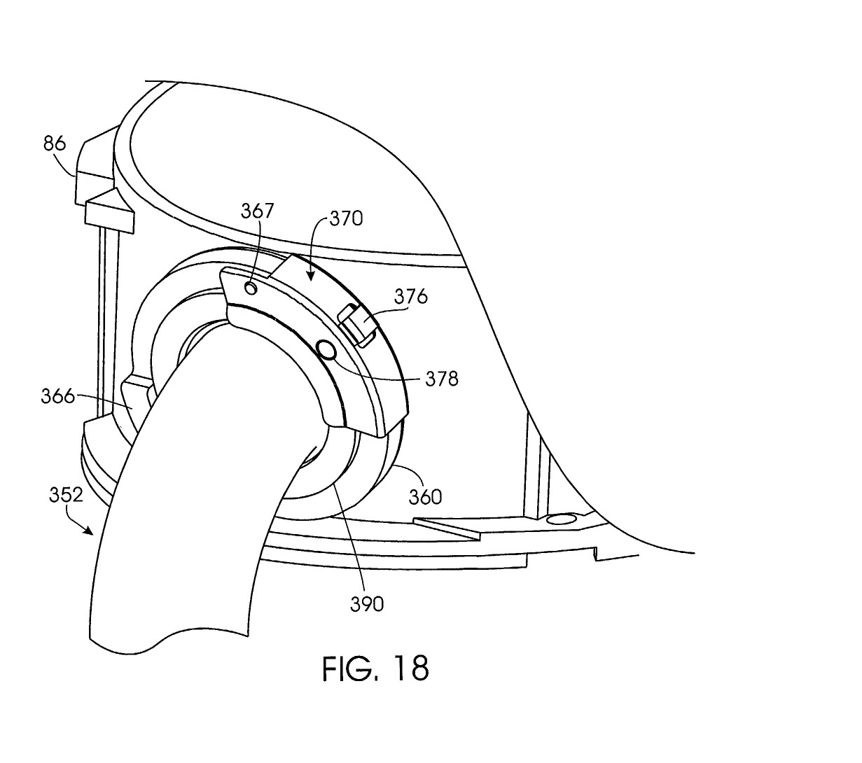

Referring to FIGS. 17 and 18, a sixth embodiment of a connector assembly 350 for a disposer is illustrated in accordance with the present invention. In FIG. 17, the connector assembly 350 is illustrated in an exploded view. In FIG. 18, the connector assembly 350 is shown assembled for connecting a waste line 352 to a grinding section (not shown) of a disposer.

The connector assembly 350 includes a first connector or mounting flange 360, a locking member or pivoting collar 370, a gasket 380, and a second connector or connector flange 390. The mounting flange 360 includes a locking portion having a boss 367, detent 368, and indentation 369. The boss 367, detent 368, and indentation 369 are used to lock the collar 370 to the mounting flange 360 as described below.

The locking member or pivoting collar 370 is preferably composed of a metallic material, but can be composed of a plastic material. The collar 370 includes a top wall 372 connected between first and second side walls 374 and 375. The top wall 372 includes a handle or clip element 376, which facilitates locking and unlocking the collar as described below. The first sidewall 374 includes an aperture 377 defined therein on a portion of the wall extending beyond the top wall 372. The collar 370 is pivotable about the boss 367 disposed in the aperture 377 and is preferably already attached to the mounting flange 360 for the installer. The first and second sidewalls 374 and 375 each include an inset dimple 378 and 379 defined therein adjacent the biasing element 376. In the present embodiment, the handle or clip element 376 is intended to capture the work end of a flat screw driver for unlocking and locking collar 370 relative to the dimples 378 and 379.

After fitting the gasket 380 on the rim 354 of the waste line 352, disposing the connector flange 390 on the waste line 352, and anchoring the connector flange 390 on the mounting flange 360 as described previously, the installer tilts the second portion 398 of the connector flange 390 adjacent the mounting flange 360. The installer then positions the aperture 377 of the collar 370 onto the boss 367 of the mounting flange 360. The installer rotates the collar 370 on the boss 367 to position the top wall 372 adjacent the mounting flange 360.

The dimples 378 and 379 rest in the second portion 398 of the connector flange 390 and in the indentation 369 to hold the collar 370 in place and resist accidental pivoting. The sidewall 374 holds the top or second portion 398 of the connector flange 390 against the mounting flange 360. This system may provide tool free installation.

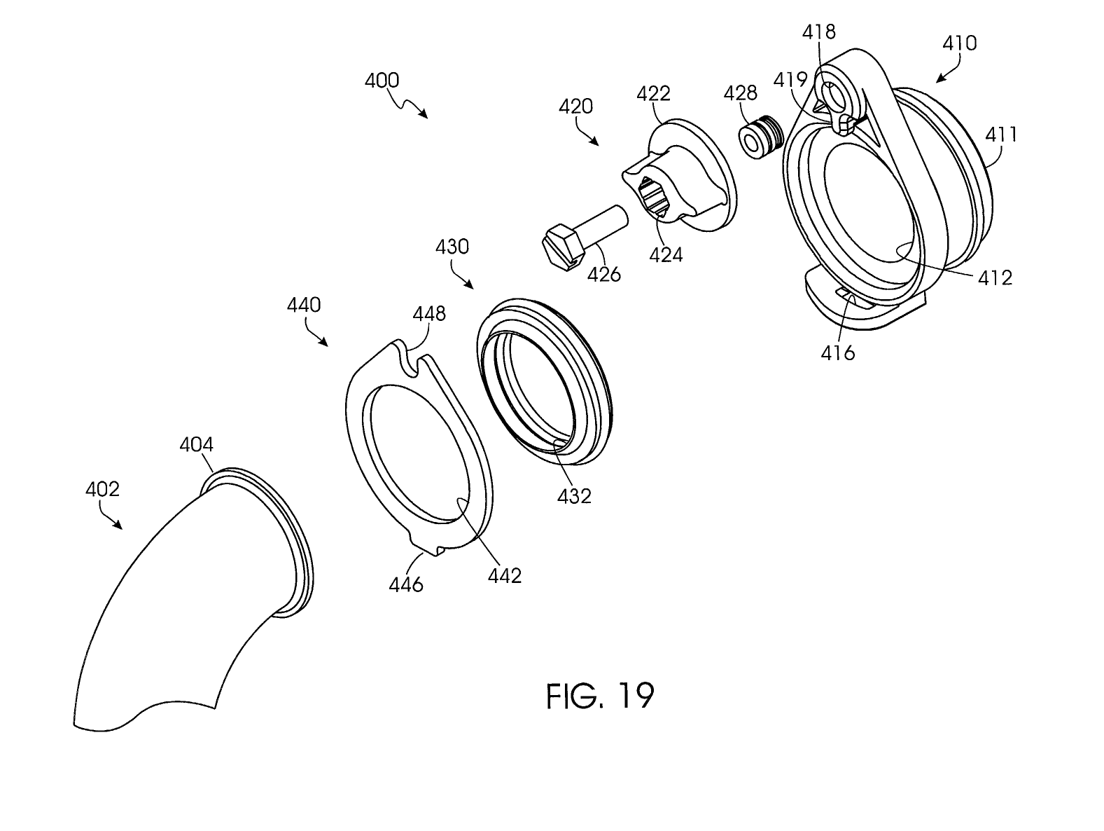

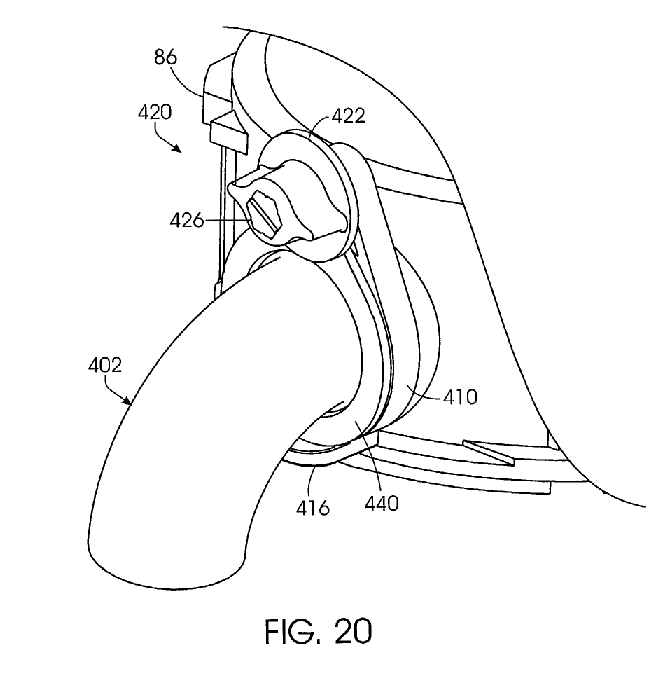

Referring to FIGS. 19 and 20, a seventh embodiment of a connector assembly 400 for a disposer is illustrated in accordance with the present invention. In FIG. 19, the connector assembly 400 is illustrated in an exploded view. In FIG. 20, the connector assembly 400 is shown assembled for connecting a waste line 402 to a grinding section (not shown) of a disposer.

The connector assembly 400 includes a first connector or mounting flange 410, a locking member 420, a gasket 430, and a second connector or connector flange 440. In the present embodiment, the mounting flange 410 includes a tubular portion 411, which is disposed in and couples to a discharge outlet of a grinding section by methods known in the art. It is understood that, in this and other embodiments, the mounting flange 410 can be coupled to the housing of the grinding section by a number other methods known in the art. The mounting flange 410 includes a locking portion 418, which is a hole in the present embodiment. The locking member 420 includes a rotatable member or wing nut shroud 422, a threaded fastener 426, and an insert 428. For example, the threaded fastener can be a ¼-20 UNC-2A slotted hex screw. The insert 428 is disposed in the hole 418 and is permanently affixed to the mounting flange 410. Alternatively, the threaded insert 428 may be replaced by a threaded hole in the mounting flange 410. The wing nut shroud 422 defines an aperture 424. The fastener 426 is disposed in the wing nut shroud 422. The fastener 426 may be held fast with crush ribs incorporated in the aperture 424 in the shroud 422. Alternatively, the fastener/shroud combination 422/426 may be a single part.

After fitting the gasket 430 on the rim 404 of the waste line 402, disposing the connector flange 440 on the waste line 402, and anchoring the connector flange 440 on the mounting flange 410 as described previously, the installer tilts the second portion 448 of the connector flange 440 adjacent the mounting flange 410. The mounting flange 410 may include a dimple 419 adjacent the hole 418 to fit within the locking slot 448 on the connector flange 440. The installer then screws the fastener/shroud combination 422/426 into the threaded insert 428 affixed in the hole 418 of the mounting flange 410. The shroud 422 holds the end 448 of the connector flange 440 against the mounting flange 410. This system provides for a tool free installation.

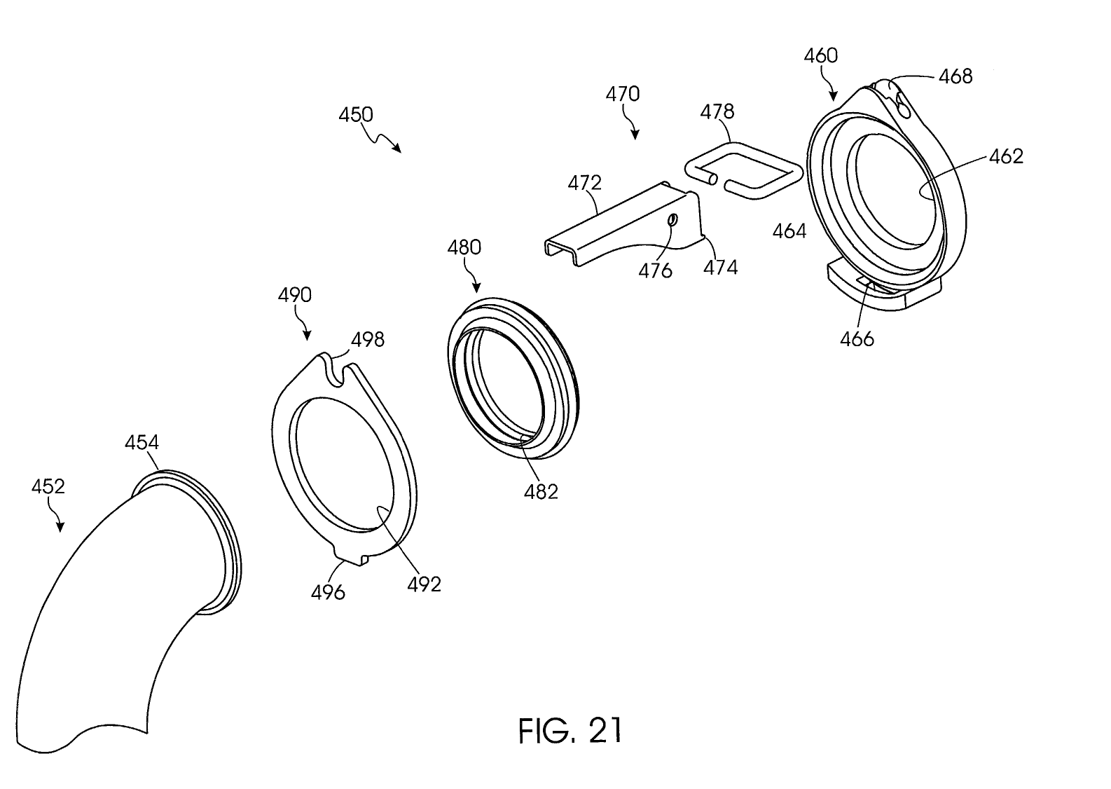

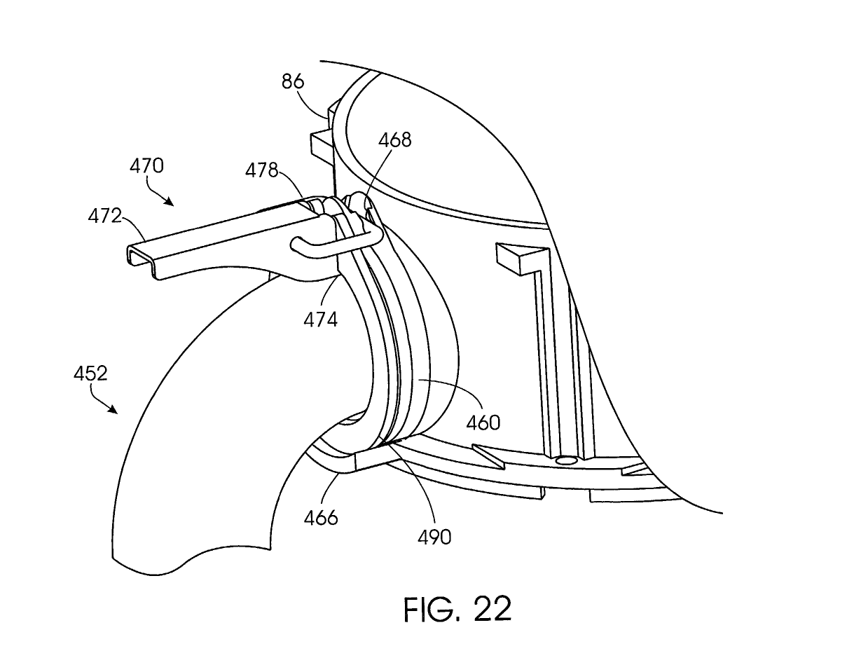

Referring to FIGS. 21 and 22, an eighth embodiment of a connector assembly 450 for a disposer is illustrated in accordance with the present invention. In FIG. 21, the connector assembly 450 is illustrated in an exploded view. In FIG. 22, the connector assembly 450 is shown assembled and connecting a waste line 452 to a grinding section 86 of a disposer.

The connector assembly 450 includes a first connector or mounting flange 460, a locking member or clamp 470, a gasket 480, and a second connector or connector flange 490. The mounting flange 460 includes a locking portion 468, which is a slot used to couple the clamp 470 to the mounting flange 460. In this as in other embodiments, the mounting flange 460 is preferably integral to the grinding section 86 of the disposer. As noted above, the mounting flange 460 is preferably pre-attached to the grinding section, requiring no assembly by an installer.

The clamp 470 includes a handle 472 and a ring 478, which can be composed of plastic or metallic materials. The ring 478 is attached to apertures 476 in the handle 472 and is attached to or snap fit into the slot 468 in the mounting flange 460. The handle 472 can include feet or tabs 474. In the present embodiment, wire ring 478 snap fits into the slot 468 to form the pivotable link between the clamp 470 and the mounting flange 460. Alternatively, the pivotable link could be a strut pivotably affixed to the handle 472 and the mounting flange 460 or could be a hinge structure known in the art.

After fitting the gasket 480 on the rim 454 of the waste line 452, disposing the connector flange 490 on the waste line 452, and anchoring the connector flange 490 on the mounting flange 460 as described previously, the installer tilts the second portion 498 of the connector flange 490 adjacent the mounting flange 460. The installer then pulls the handle 472 away from the housing of the grinding section 86. As best shown in FIG. 22, the handle 472 is pulled down until it positions adjacent the waste line 452 and presses against the connector flange 490. The over-center position of the handle 472 and ring 478 resists accidental release of the clamp 470. The feet or tabs 474 of the handle 472 may wedge between the connector flange 490 and the waste line 452 for positive alignment and resistance to accidental unlocking.

As disclosed herein, the first connectors or mounting flanges according to the present invention can be coupled to the housing of the grinding section by a number of methods known in the art, including, but not limited to, integrally forming the first connector on the housing, molding the first connector on the housing, or affixing the first connector to the housing with fasteners. Furthermore, the second connectors or connector flanges according to the present invention can be coupled to the waste line by a number of methods known in the art, including, but not limited to, integrally forming the second connector on the waste line or engaging the second connector on a rim of the waste line.

While the present invention has been described with reference to particular embodiments, those skilled in the art will recognize that many changes may be made thereto without departing from the spirit and scope of the present invention. For example, one skilled in the art would understand that a male and a female member or connector could be switched. For example, a male member could be attached to a waste line and a female member could be attached to a housing of a waste disposer, or the relations could be reversed. These and other embodiments and obvious variations thereof are contemplated as falling within the spirit and scope of the claimed inventions, which are set forth in the following claims.

What is claimed is:

1. A connector assembly for attaching a waste line to a waste disposer, comprising:
a first connector coupled to the waste disposer and having one or more anchors;
a second connector coupled to the waste line and having one or more locking members adapted to lock the second connector to the one or more anchors of the first connector.

2. The connector assembly of claim 1, further comprising a seal on the first connector for sealably engaging the second connector.

3. The connector assembly of claim 1, further comprising a gasket disposed in the first connector for creating a seal with the second connector.

4. The connector assembly of claim 3, wherein the gasket fits on a rim of the waste line.

5. The connector assembly of claim 1, wherein the one or more anchors comprise a plurality of tabs disposed about the first connector, and wherein the one or more locking members comprise a plurality of slots defined in the second connector and locking on the tabs of the first connector.

6. The connector assembly of claim 5, wherein the second connector comprises a female member inserting on the first connector, the first connector being a male member.

7. The connector assembly of claim 6, wherein the plurality of slots each comprise a first portion receiving one of the tabs when the female member is inserted on the male member, and a second portion receiving the one tab when the female member is turned on the male member.

8. The connector assembly of claim 7, wherein the plurality of tabs each comprise a leading end on a side of the tab adjacent the disposer, the leading end being slanted.

9. The connector assembly of claim 1, wherein the one or more anchors comprise a ridge disposed about the first connector, and wherein the one or more locking members comprise a plurality of levers disposed on the second connector and having catches for locking on the ridge of the first connector.

10. The connector assembly of claim 9, wherein the second connector comprises a female member inserting on the first connector, the first connector being a male member.

11. The connector assembly of claim 10, wherein the plurality of levers each comprise a member having one end attached to the female member and being capable of moving the catch away from the ridge of the male member, the catch being disposed adjacent the one end of the member on an inner surface of the female member.

12. The connector assembly of claim 1, wherein the one or more anchors comprise a plurality of tabs disposed about the first connector, and wherein the one or more locking members comprise a plurality of hooks extending from a side of the second connector for locking on the tabs of the first connector.

13. The connector assembly of claim 12, wherein first connector comprises a cylindrical body extending from the disposer and having the plurality of tabs disposed about a periphery of the cylindrical body.

14. The connector assembly of claim 13, wherein the second connector comprises a flange having an opening and disposing on the waste line, the flange engaging a rim and a gasket on an end of the waste line.

15. The connector assembly of claim 12, wherein the plurality of hooks each comprise:
a first portion extending from the side of the flange, and
a second portion on an end of the first portion and extending inward, the second portion engaging a side of one of the tabs adjacent the disposer.

16. The connector assembly of claim 15, wherein the plurality of tabs each comprises a leading end being slanted, and an indented portion adjacent the leading end and defined in the side of the tab adjacent the disposer.

17. The connector assembly of claim 16, wherein the second portions of the hooks each comprise a raised portion disposing in the indented portion of the tab.

18. A connector assembly for attaching a waste line to a waste disposer, comprising:
a first connector coupled to the disposer and having a locking portion and an anchor portion;
a second connector coupled to the waste line and having a first portion, the anchor portion holding the first portion adjacent the first connector; and
a locking member attached to the locking portion and holding a second portion of the second connector adjacent the first connector.

19. The connector assembly of claim 18, further comprising a gasket disposed in the first connector for creating a seal with the second connector.

20. The connector assembly of claim 19, wherein the gasket fits on a rim of the waste line.

21. The connector assembly of claim 18, wherein the first connector is affixed to the disposer with fasteners, is integrally formed with a housing of the disposer, or is molded onto the housing of the disposer.

22. The connector assembly of claim 18, wherein the second connector engages a rim and a gasket on an end of the waste line.

23. The connector assembly of claim 18, wherein the anchor portion comprises a slot defined in the first connector, and wherein the first portion of the second connector comprises a tab on an end of the second connector coupleable to the slot.

24. The connector assembly of claim 18, wherein the locking member comprises a handle hingedly attached to the locking portion.

25. The connector assembly of claim 24, wherein the locking member comprises a ring attached to the handle and snap fit into a slot in the first connector.

26. The connector assembly of claim 18, wherein the locking member comprises a collar pivotably attached to the locking portion.

27. The connector assembly of claim 26, wherein the collar comprises a hole pivotably disposing on a boss on the second connector.

28. The connector assembly of claim 26, wherein the collar comprises locking tabs on first and second sidewalls and disposing in holes or indentations defined in the first connector.

29. The connector assembly of claim 18, wherein the locking member comprises a key having one end retained in a keyhole and having another end engaging the second portion of the second connector.

30. The connector assembly of claim 29, wherein the one end of the key has a tooth disposing in a detent defined in the first connector.

31. The connector assembly of claim 18, wherein the locking member comprises a fastener having one end attached to the locking portion and having a shroud on another end engaging the second portion of the second connector.

32. The connector assembly of claim 18, wherein the locking member comprises a rotatable member having one end attached to the locking portion and having a cam on another end engaging the second portion of the second connector.

33. The connector assembly of claim 32, wherein the cam is disposed on one side of the rotatable member.

34. The connector assembly of claim 32, wherein the cam comprises a detent on a side adjacent the first connector and disposing in a slot defined in the second connector.

35. A method of attaching a first connector to a second connector, the first connector coupled to a disposer and the second connector coupled to a waste line, the method comprising:
a) anchoring a first portion of the second connector on the first connector; and
b) locking a second portion of the second connector on a locking portion of the first connector.

36. The method of claim 35, further comprising disposing a gasket between the first connector and the second connector before positioning the second connector adjacent the first connector.

37. The method of claim 35, wherein step (a) comprises disposing a tab on an end of the second connector in a slot defined in the first connector.

38. The method of claim 37, wherein step (b) comprises locking a key in the second connector and engaging an end of the second connector with the key.

39. The method of claim 35, wherein step (b) comprises clamping a handle hingedly attached to the first connector against the second connector.

40. The method of claim 35, wherein step (b) comprises clamping a collar pivotally attached to the first connector against the second connector.

41. The method of claim 35, wherein step (b) comprises attaching a fastener to the first connector and engaging an end of the second connector with a shroud on the fastener.

42. The method of claim 35, wherein step (b) comprises rotating a cam attached to the first connector and engaging an end of the second connector with the cam.

43. The method of claim 35, wherein step (a) comprises positioning a female member on a male member.

44. The method of claim 35, wherein step (b) comprises locking a plurality of slots defined in the second connector on a plurality of tabs disposed about the first connector.

45. The method of claim 35, wherein step (b) comprises locking a plurality of catches on levers attached to the second connector on a ridge disposed about the first connector.

46. The method of claim 35, wherein step (b) comprises locking a plurality of hooks on the second connector on a plurality of tabs disposed about the first connector.
